(19) United States
(12) Patent Application Publication
(10) Pub. No.: US 2015/0205798 A1
(43) Pub. Date: Jul. 23, 2015

(54) INFORMATION SEARCH SUPPORT METHOD AND APPARATUS

(71) Applicant: FUJITSU LIMITED, Kawasaki-shi (JP)

(72) Inventor: Akira KARASUDANI, Yamato (JP)

(73) Assignee: FUJITSU LIMITED, Kawasaki-shi (JP)

(21) Appl. No.: 14/674,683

(22) Filed: Mar. 31, 2015

Related U.S. Application Data
(63) Continuation of application No. PCT/JP2012/076094, filed on Oct. 9, 2012.

(51) Int. Cl. G06F 17/30

(52) U.S. Cl. CPC G06F 17/3053; G06F 17/30554; G06F 17/30011

(57) ABSTRACT

This information search support method includes: upon detecting that a first operation of a user is an operation relating to browsing, performing search associated with data relating to the browsing to obtain a search result; extracting first feature data from the search result; upon detecting that a second operation of the user after the first operation is an operation relating to searching, adding data relating to the second operation to an operation history; extracting second feature data from the operation history; calculating a fitness degree between the first feature data and the second feature data; and upon detecting that the fitness degree is equal to or greater than a threshold, displaying the search result for the user.

### CROSS-REFERENCE TO RELATED APPLICATIONS

This application is a continuing application, filed under 35 U.S.C. section 111(a), of International Application PCT/JP2012/076094, filed on Oct. 9, 2012, the entire contents of which are incorporated herein by reference.

### FIELD

This technique relates to a technique for supporting information search.

### BACKGROUND

Burdens to manage information such as a huge volume of files and/or mail that a user has are increasing. Even if information is categorized hierarchically by directories and/or folders, for example, the user cannot manage the information in case the user forgets a rule for the hierarchies. In addition, a problem occurs that the user cannot come to mind proper search conditions even when the user would like to retrieve the information.

In order to solve such problems, a technique is proposed that a search condition is automatically extracted from operation contents and the like of a terminal such as a personal computer and/or smart phone of a user to extract web contents and/or information within the terminal, which are associated with current operation contents document browsing, selected keyword and/or like). In such a technique, the search condition is automatically generated. Therefore, the user does not have to come to mind any search condition. Moreover, a technique for displaying a result of the automatic search on a screen of the terminal in this technique is proposed as follows.

(a) Method that a user instructs to display the search result (to select an icon or menu for displaying the search result)

In this method, the search result is not displayed unless the user instructs. Therefore, a means for notifying the user that the search has been automatically performed is employed. However, when the search result is displayed for the user, for example, by a pop-up menu or the like in order to notify the event, there is a possibility that the user's job is interrupted and impeded every time when this screen is displayed. Moreover, the user's instruction itself is a burden.

(b) Method that the search result is automatically displayed immediately after the automatic search

In such a method, because the search result is displayed without any relationship with the user's job status every automatic search, there is a possibility that the user's job is interrupted and impeded by the display of the search result.

(c) Method that the automatic search result is displayed at a timing when a document is browsed to the last

Because the search result is displayed without any relationship with a job after the user browses the document, the job may be interrupted and impeded after all.

According to the aforementioned problems, it is desirable that the search result is displayed at an appropriate timing (i.e. the timing when the user wants to see the search result associated with the present job) without obstructing the user's job. However, the conventional arts cannot do this.

Patent Document 1: Japanese Laid-open Patent Publication No. 09-198184

Patent Document 2: Japanese Laid-open Patent Publication No. 2003-132049

Patent Document 3: Japanese Laid-open Patent Publication No. 2005-173999

Patent Document 4: Japanese Laid-open Patent Publication No. 2006-293936

Patent Document 5: Japanese Laid-open Patent Publication No. 2007-241525

Patent Document 6: Japanese Laid-open Patent Publication No. 2010-67147

Patent Document 7: Japanese Laid-open Patent Publication No. 2008-20961

Patent Document 8: Japanese Laid-open Patent Publication No. 2002-149668

Patent Document 9: Japanese Laid-open Patent Publication No. 2006-338346

Therefore, there is no technique for enabling to display the search result at the timing when a user desires.

### SUMMARY

An information search support method relating to this technique includes: (A) upon detecting that a first operation of a user is an operation relating to browsing, performing search associated with data relating to the browsing to obtain a search result; (B) first extracting first feature data from the search result; (C) upon detecting that a second operation of the user after the first operation is an operation relating to searching, adding data relating to the second operation to an operation history; (D) second extracting second feature data from the operation history; (E) calculating a fitness degree between the first feature data and the second feature data; and (F) upon detecting that the fitness degree is equal to or greater than a threshold, displaying the search result for the user.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram depicting a software configuration example relating to an embodiment;

FIG. 2 is a functional block diagram of an information processing apparatus relating to this embodiment;

FIG. 3 is a diagram depicting a processing flow of a processing executed by the information processing apparatus;

FIG. 4 is a diagram depicting a processing flow of a processing executed by the information processing apparatus;

FIG. 5 is a diagram depicting a temporal relationship between a browsing operation and a search operation;

FIG. 6 is a diagram depicting a processing flow of a processing executed by the information processing apparatus;

FIG. 7 is a diagram depicting an example of search results;

FIG. 8 is a diagram depicting an example of a search operation history;

FIG. 9 is a diagram depicting a first display screen example;

FIG. 10 is a diagram depicting a second display screen example;

FIG. 11 is a diagram depicting a third display screen example; and

FIG. 12 is a functional block diagram of a computer.

### DESCRIPTION OF EMBODIMENTS

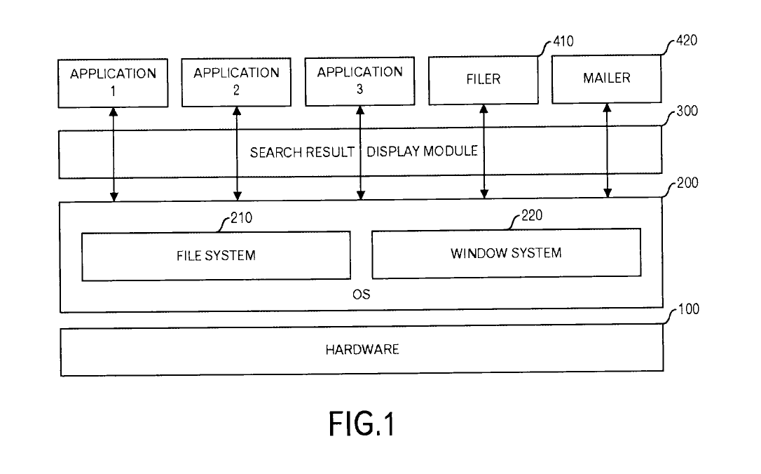

A software configuration example of an information processing apparatus relating to an embodiment of this technique is explained by using FIG. 1. As illustrated in FIG. 1, on hardware 100 of the information processing apparatus relating to this embodiment, an Operating System (OS) 200 that has a file system 210 and a window system 220, a search result display module 300 that executes a main processing relating to this embodiment, and application programs such as applications 1 to 3 such as a word processor, a filer 410, a mailer 420 and the like are executed from a lower layer to a higher layer.

The OS 200 and application programs such as the applications 1 to 3 are the same as the conventional ones. The search result display module 300 hooks messages between the OS 200 and applications, and executes a processing according to the messages. Detailed explanation will be made in the following, however, when detecting a message relating to a user's browsing operation, contents associated with the browsing is searched. Moreover, when the search result display module 300 detects a message relating to a search operation by the user after the browsing operation, the search result display module 300 adds data concerning the search operation to a search operation history, and also extracts feature data from the search operation history. Then, the search result display module 300 calculates a fitness degree between the feature data extracted from the search operation history and the feature data extracted from the search result, and displays the search result for the user when the fitness degree exceeds a threshold.

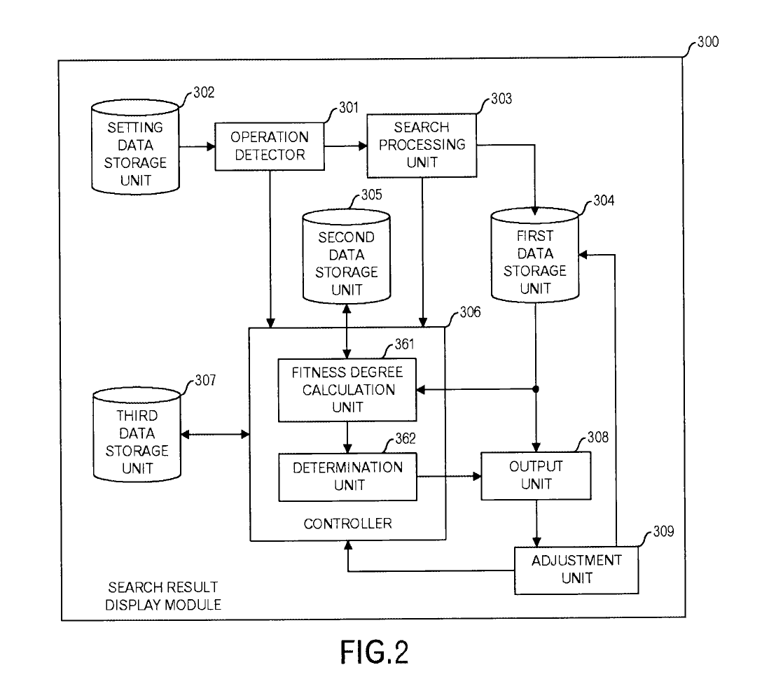

Next, an example of a functional block configuration realized in the information processing apparatus by the search result display module 300 will be explained by using FIG. 2. In other words, by the search result display module 300, the information processing apparatus has an operation detector 301, a setting data storage unit 302, a search processing unit 303, a first data storage unit 304, a second data storage unit 305, a controller 306, a third data storage unit 307, an output unit 308, and an adjustment unit 309. Moreover, the controller 306 has a fitness degree calculation unit 361 and a determination unit 362.

The setting data storage unit 302 stores setting data such as types of messages that are determined as the search operation, types of messages that are determined as the browsing operation and the like, for example. The operation detector 301 hooks messages between the application programs and OS 200, and detects the search operation and browsing operation based on the setting data of the message types, which is stored in the setting data storage unit 302.

When the operation detector 301 detects the browsing operation, the operation detector 301 outputs data of the message concerning the browsing operation to the search processing unit 303. When the search processing unit 303 receives the data concerning the browsing operation, the search processing unit 303 obtains data associated with the browsing contents (e.g. contents of a file and/or a web page, which is browsed.) to generate a search condition, and automatically performs search for the file system 210, for example. The search processing unit 303 stores the search results in the first data storage unit 304. Moreover, the operation detector 301 notifies the controller 306 that the browsing operation was performed.

When the operation detector 301 detects the message concerning the search operation, the operation detector 301 outputs the message to the controller 306. The controller 306 adds data of the present search operation to the search operation history stored in the second data storage unit 305 when the present operation is the search operation after the browsing operation.

Moreover, the fitness degree calculation unit 361 extracts feature data from the search result stored in the first data storage unit 304, and stores the extracted feature data in the third data storage unit 307, for example. In addition, the fitness degree calculation unit 361 extracts feature data from the data of the search operation history, which is stored in the second data storage unit 305, and stores the extracted feature data in the third data storage unit 307, for example. Then, the fitness degree calculation unit 361 calculates a fitness degree between the feature data extracted from the search result and the feature data extracted from the search operation history, and outputs the calculated fitness degree to the determination unit 362. The determination unit 362 determines whether or not the fitness degree exceeds the threshold, and when the fitness degree exceeds the threshold, the determination unit 362 causes the output unit 308 to display the search result stored in the first data storage unit 304. When the fitness degree does not exceed the threshold, the determination unit 362 does not instruct the output unit 308. The fitness degree calculation unit 361 and the determination unit 362 recalculate the fitness degree whenever the search operation history stored in the second data storage unit 305 is updated, and determine whether or not the fitness degree exceeds the threshold.

The adjustment unit 309 determines whether or not the user performed any operation representing the utilization for the search result outputted by the output unit 308 such as browsing within a predetermined time, and changes the threshold of the fitness degree or the like, which is used in the controller 306, according to the determination result.

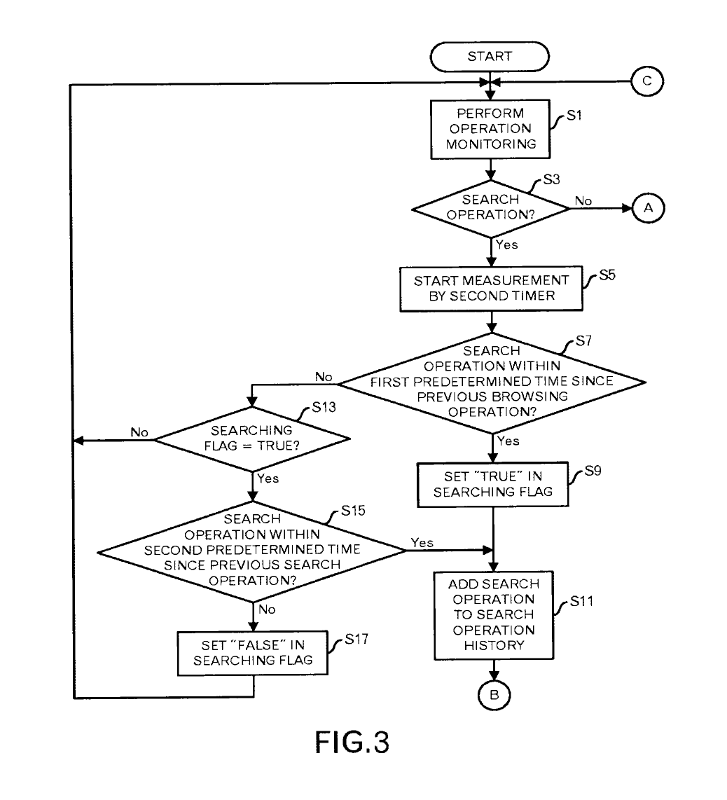

In the following, a processing executed by the configuration illustrated in FIGS. 1 and 2 will be explained by using FIGS. 3 to 11.

The operation detector 301 executes a monitoring processing of operations by the user by monitoring exchange of messages between the application programs and the OS 200 (FIG. 3: step S1).

Then, the operation detector 301 determines, whether or not a search operation is performed by the user, from the received message based on the setting data stored in the setting data storage unit 302 (step S3).

For example, when an operation to activate the filer 410 that is an application program to open a file, to shift an active window to a window of the filer 410 that has been activated, or to shift to another folder by the filer 410 that has been activated was performed, it is determined that the search operation was performed.

Moreover, for example, when an operation to activate the mailer 420 that is an application program to browse e-mail, or to shift the active window to a window of the mailer 420 that has been activated to refer to a folder that is other than a folder (e.g. receiving tray or the like) for newly received or unprocessed mail or to a folder that is other than a currently browsed folder was performed, it is determined that the search operation was performed.

Furthermore, when an operation to designate (e.g. search box) a search function in the filer 410 or mailer 420 was performed, it may be determined that the search operation was performed.

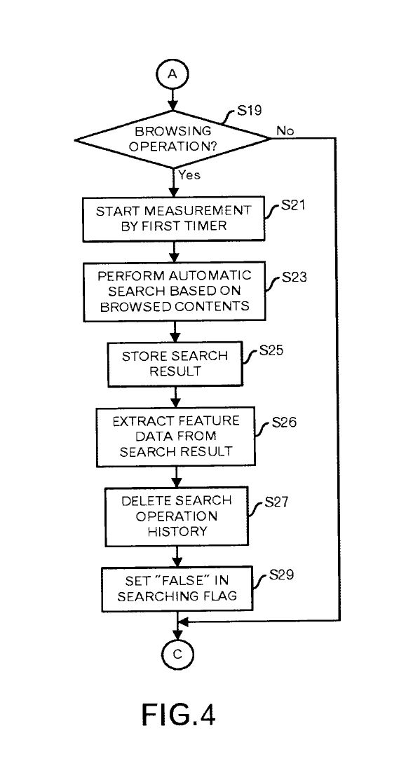

When the search operation is not performed, the processing shifts to a processing in FIG. 4 through terminal A. Here, the processing in FIG. 4 will be explained firstly.

The operation detector 301 determines, based on the setting data and from the received message, whether or not the browsing operation was performed by the user (step S19). When the present operation is not the browsing operation, the processing returns to the step S1 in FIG. 3 through terminal C.

On the other hand, when the browsing operation was performed, the operation detector 301 notifies the controller 306 that the browsing operation was performed, and the controller 306 starts measuring time since the browsing operation by a first timer in response to this notification (step S21). When the measuring has already been started, the time is returned to “0”. Moreover, the operation detector 301 outputs data of the received message to the search processing unit 303, and the search processing unit 303 identifies browsing contents of the user from the data of the received message, and performs automatic search based on the browsing contents (step S23).

For example, when a browsing operation to open a specific file by a word processor is detected, when a browsing operation to open a specific mail by the mailer 420 is detected or when a browsing operation to open a specific web page by a web browser is detected, a search condition is extracted from an opened file, or data of the mail or web page. For example, keywords are extracted from data of the file or the like, and the search condition is generated by the extracted key words. Moreover, a search condition may be generated from properties or the like such as an access time of a file and a user name. Then, by using the search condition, a boolean search, vector search or the like is performed. The search destination may be sources within its own information processing apparatus, or may be another computer connected through a network.

The browsing operation includes not only opening a file or the like but also moving a focus to a window in which a file is opened.

Moreover, the search processing unit 303 stores the search results in the first data storage unit 304 (step S25). As described above, the search result is not outputted immediately. Moreover, the search processing unit 303 notifies the controller 306 of the completion of the search processing. Then, the fitness degree calculation unit 361 of the controller 306 extracts feature data from the search result stored in the first data storage unit 304, and stores the extracted feature data in the third data storage unit 307 (step S26). The processing of this step will be explained in detail compared with a processing to extract feature data from the search operation history.

Moreover, the controller 306 deletes data of the search operation history stored in the second data storage unit 305 (step S27). In addition, the controller 306 sets “FALSE” for a searching flag (step S29). Then, the processing returns to the step S1 in FIG. 3 through terminal C.

When the browsing operation is performed as described above, the search is automatically performed, and a search result to support the search operation that is presumed to be performed hereinafter is prepared. However, because the search result is displayed only when the search result is in conformity with a direction of the search operation that is presumed to be performed hereinafter, the search result is not displayed when the browsing operation was performed.

Returning to the explanation of the processing in FIG. 3, when it is detected at the step S3 that the search operation was performed, the operation detector 301 outputs data of the message relating to the search operation to the controller 306. Then, the controller 306 starts measuring an interval of the search operations by a second timer (step S5). When the measuring has already been started, the value of the timer is returned to “0”.

Then, the controller 306 determines, from the value of the first timer, whether or not the current search operation is a search operation within a first predetermined time T1 since the previous browsing operation (step S7). When the search operation has not been performed too long since the previous browsing operation, there is a possibility that the user already changed his or her consideration to another viewpoint and the search result that was obtained according to the previous browsing operation is not effective. Then, it is confirmed at this step whether or not the current search operation is a search operation performed within the first predetermined time T1 since the previous browsing operation. In this embodiment, when the value of the first timer is “0” because the browsing operation has not been executed before the search operation, it is determined that the condition of the step S7 is not satisfied.

When the current search operation is a search operation within the first predetermined time T1 since the previous browsing operation, the controller 306 sets “TRUE” in the searching flag (step S9). Then, the controller 306 adds the search operation that was detected this time to the search operation history in the second data storage unit 305 (step S11). Then, the processing shifts to a processing in FIG. 6 through terminal B.

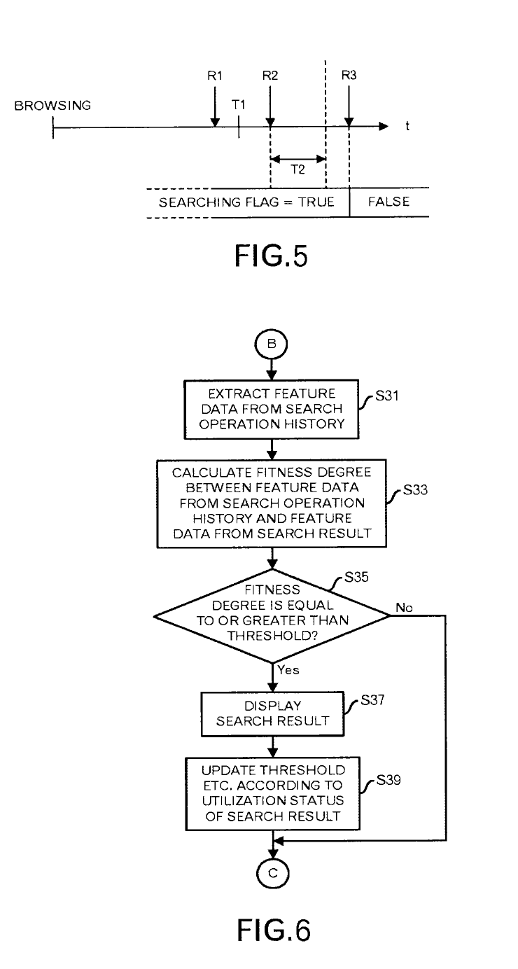

On the other hand, when the current search operation is not a search operation performed within the first predetermined time T1 since the previous browsing operation, the controller 306 determines whether or not the searching flag represents “TRUE” (step S13). When the searching flag represents “TRUE”, the step S9 was performed past. Therefore, as illustrated in FIG. 5, the search operation R1 was performed at least once within the first predetermined time T1 since the browsing operation. In other words, when the searching flag represents “TRUE”, it is possible to determine that there is a possibility that the search is continuously performed. When the searching flag represent “FALSE” , the search operation is not performed once. Therefore, the processing returns to the step S1.

On the other hand, when the searching flag represents “TRUE”, the controller 306 determines, from the value of the second timer, whether or not the current search operation is a search operation performed within a second predetermined time T2 since the previous search operation (step S15). As illustrated in FIG. 5, when the search operation R2 was performed within the second predetermined time T2 after the search operation R1, it is confirmed that the search is continuously performed. On the other hand, as illustrated in FIG. 5, when the search operation R3 was performed after the second predetermined time T2 elapsed after the search operation R2, there is a possibility that the search is not continuously performed, and the search operation is already performed in a different viewpoint.

Therefore, when the current search operation is not the search operation performed within the second predetermined time T2 since the previous search operation, the controller 306 changes the searching flag to “FALSE” as illustrated in FIG. 5 (step S17). Then, the processing returns to the step S1. In other words, the search result stored in the first data storage unit 304 is not used.

On the other hand, when the current search operation is a search operation performed within the second predetermined time T2 since the previous search operation, the processing shifts to the step S11.

Next, the explanation shifts to a processing in FIG. 6. The fitness degree calculation unit 361 in the controller 306 extracts feature data from the present search operation history (including the current search operation), which is stored in the second data storage unit 305 (step S31).

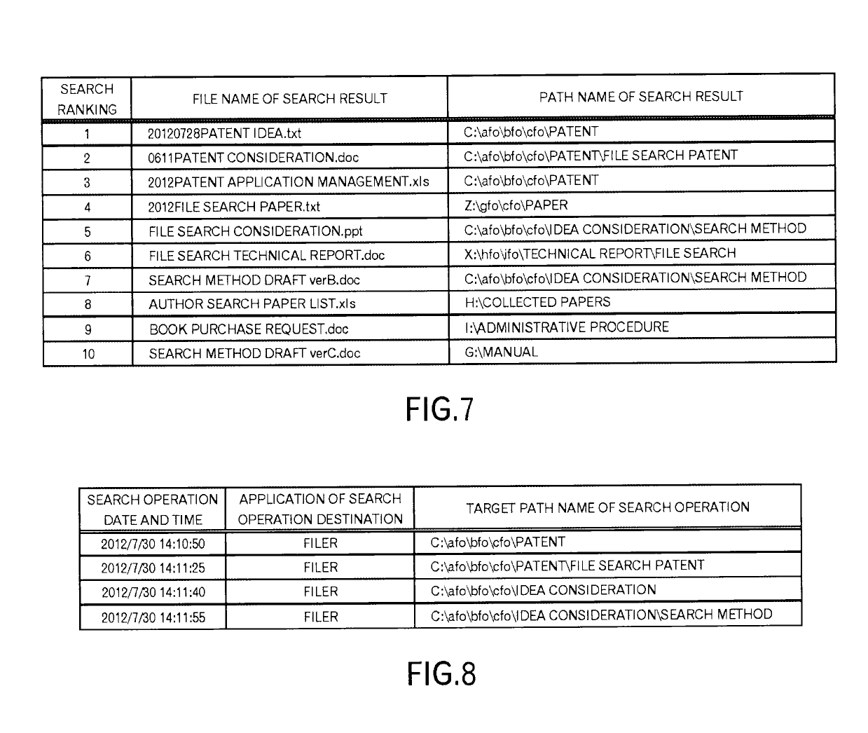

This step will be explained compared with the step S26. For example, it is assumed that the search result as illustrated in FIG. 7 was obtained. In an example of FIG. 7, as for each search ranking up to 10-th ranking, a file name of the search result and a path name (i.e. directory name) of the search result are included as the search result. At the step S26, as a first specific example, a path name (i.e. directory name) of the search result is extracted as the feature data. As a second specific example, keywords are extracted from the path name (i.e. directory name) of the search result, a weight value for each keyword is calculated (e.g. TF-IDF value), and a weight vector is calculated as the feature data. Furthermore, as a third specific example, keywords are extracted from the file and the like of the search result, a weight value for each keyword is calculated (e.g. TF-IDF value), and a weight vector is calculated as the feature data.

The TF-IDF value is a product of a weight TF value (i.e. a value representing completeness) for an appearance frequency of the keyword and an IDF value (i.e. a value representing specificity) that is an inverse value of the appearance frequency of the document in which the keyword appears. More specifically, the TF value is calculated as follows:

TF=(the number of appearance times of a keyword t in a document d)/(the total number of keywords in the document d)

In addition, the IDF value is calculated as follows:

IDF=1+ln (the total number of documents/the number of documents in which the keyword t appears)

For example, as for the keyword that appears in plural search rankings, a statistical value (e.g. the maximum value, the minimum value, an average value or the like) of the TF-IDF value may be employed, or a TF-IDF value of the highest ranking may be employed.

For example, in case of the second specific example, a weight vector (afo:0.1, bfo:0.1, cfo:0.1, patent:0.3, file:0.4, search:0.4, idea:0.2, consideration:0.2, method:0.3) is calculated.

On the other hand, it is assumed data as illustrated in FIG.

8 is obtained as the search operation history, for example. In an example of FIG. 8, a search operation date and time, an application program of a search operation destination and a target path name (i.e. directory name) of the search operation are registered. At the step S31, as a first specific example, the target path name (i.e. directory name) of the search operation is extracted as the feature data as they are. As a second specific example, a path name (i.e. directory name) of lower predetermined layers (e.g. 2 lower layers) in the target path name (i.e. directory name) of the search operation is extracted as the feature data. In case of the example in FIG. 8, “cfo”, “patent”, “file search patent”, “idea consideration” and “search method” are extracted as the feature data. As a third specific example, the target path name (i.e. directory name) of the search operation is divided into words, and the extracted keywords are extracted as the feature data. In the example of FIG. 8, “afo”, “bfo”, “cfo”, “patent”, “file”, “search”, “idea”, “consideration” and “method” are extracted. As a fourth specific example, the target path name (i.e. directory name) of the search operation is divided into words to extract keywords, and for each keyword, a weight value (e.g. TF-IDF value) is calculated, and a weight vector is calculated as the feature data. As for the documents when the TF-IDF value is calculated, the entire history may be handled as one document, and the individual target path names (i.e. directory names) of the respective search operations may be handled as one document. Moreover, when the entire history is handled as one document, the calculation may be performed as handling all paths in the file system 210 in the information processing apparatus as the all documents.

For example, in the example of FIG. 8, in case of the fourth specific example, (afo:0.1, bfo:0.1, cfo:0.1, patent:0.3, file:0.4, search:0.4, idea:0.2, consideration:0.2, method:0.3) is obtained.

Then, the fitness degree calculation unit 361 calculates a fitness degree from the first feature data extracted from the search operation history and the second feature data extracted from the search result (step S33).

As the first specific example, when the path name (i.e. directory name) of the search result is extracted as the second feature data, and the target path name (i.e. directory name) of the search operation is extracted as the first feature data, a ratio of identical path names is calculated as the fitness degree. For example, when 5 path names are identical, the number of identical path names “5”/the number of search results “10”=0.5 is calculated as the fitness degree.

Moreover, as for the second specific example, when the path name (i.e. directory name) of the search result is extracted as the second feature data and the path name (i.e. directory name) for two layers in the target path name (i.e. directory name) of the search operation is extracted as the first feature data, a ratio of the number of path names (i.e. directory names) that include any of the path name (i.e. directory name) extracted as the first feature data and are extracted as the second feature data is calculated as the fitness degree. For example, the number of path names “6” that include any of the path names included in the first feature data and are included in the second feature data/the number of search results “10”=0.6 is calculated as the fitness degree.

As the third specific example, when the target path name (i.e. directory name) of the search operation is divided to extract keywords as the first feature data, and the path name (i.e. directory name) of the search result is extracted as the second feature data, a ratio of the number of path names (i.e. directory names) that include any of keywords extracted as the first feature data and are extracted as the second feature data is calculated as the fitness degree. For example, the number of path names “7” that includes any of the keywords included in the first feature data and are included in the second feature data/the number of search results “10”=0.7 is calculated as the fitness degree.

As for the fourth specific example, when the first weight vector is calculated as the first feature data, and the second weight vector is calculated as the second feature data, an inner-product of the first weight vector and the second weight vector is calculated as the fitness degree. When the first weight vector is (afo:0.1, bfo:0.1, cfo:0.1, patent:0.3, file:0.4, search:0.4, idea:0.2, consideration:0.2, method:0.3), and the second weight vector is (afo:0.1, bfo:0.1, cfo:0.1, patent:0.3, file:0.4, search:0.4, idea:0.2, consdieration:0.2, method:0.3), a total sum of products of weight values for the same keyword is calculated. In other words, 0.1*0.1 (afo)+0.1*0.1 (bfo)+0.1*0.1 (cfo)+0.3*0.3 (patent)+0.4*0.4 (file)+0.4*0.4 (search)+0.2*0.2 (consideration)+0.2*0.2 (idea)+0.3*0.3 (method)=0.61 is calculated.

The fitness degree calculation unit 361 outputs the calculated fitness degree to the determination unit 362, and the determination unit 362 determines whether or not the fitness degree is equal to or greater than a threshold (step S35). When the fitness degree is less than the threshold, the processing returns to the step S1 through terminal C. In other words, because the search operations up to this time do not match the search result, the search result is not displayed.

On the other hand, when the fitness degree is equal to or greater than the threshold, the determination unit 362 outputs an instruction to the output unit 308, and the output unit 308 outputs the search result stored in the first data storage unit 304 to a display device of the information processing apparatus (step S37).

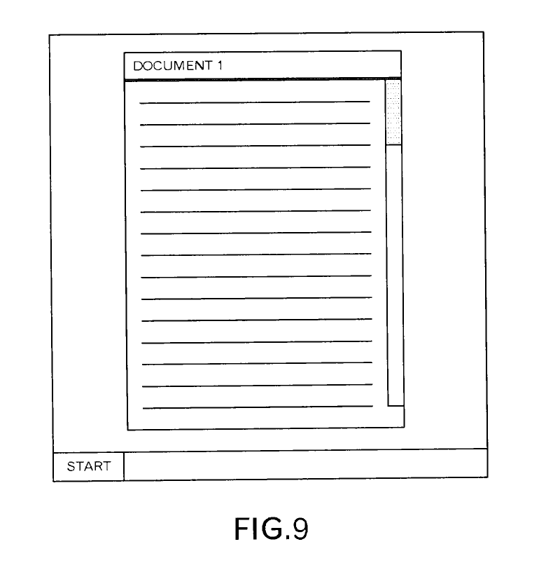

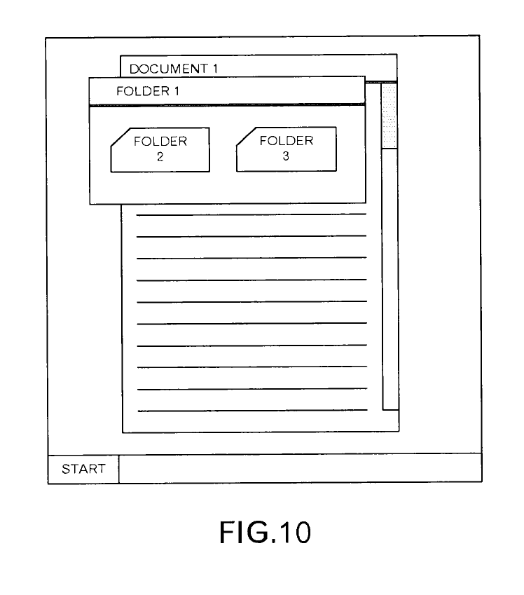

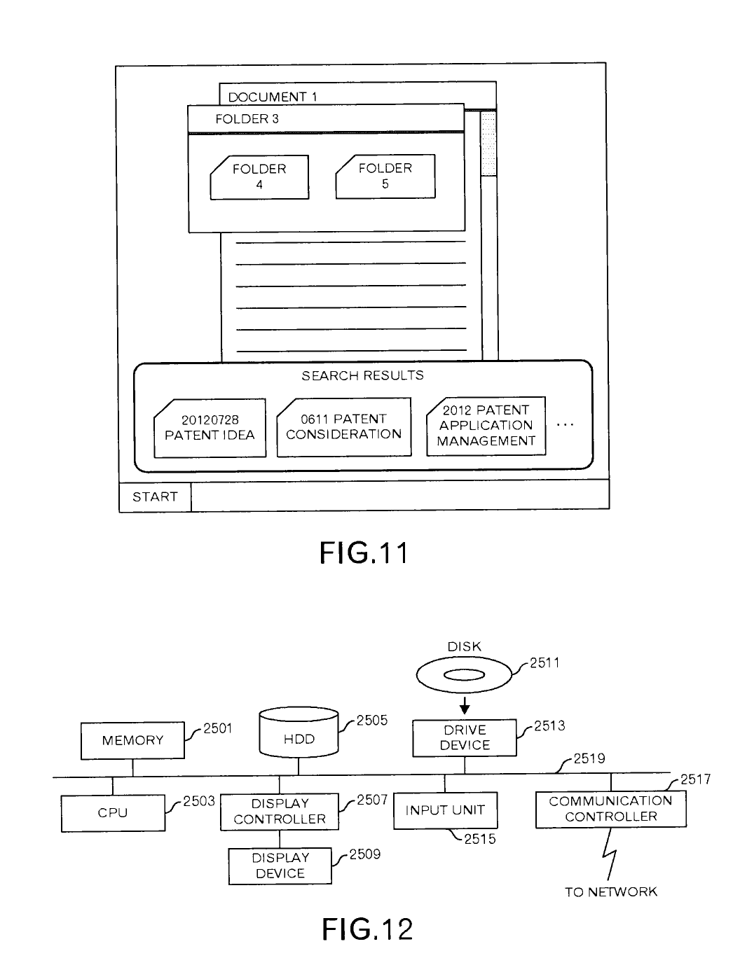

As illustrated in FIG. 9, for example, when a file “document 1” is browsed by a viewer, for example, the search is performed in the background by the search processing unit 303. After this, when the user performs the search by activating the filer 410 or the like, a display as illustrated in FIG. 10 is performed on the display device. For example, in the initial search operation, the fitness degree between the search result and search operation history is low. Therefore, the search result is not displayed. After that, when the search operation is further performed by the filer 410 or the like, it is assumed that the fitness degree between the search result and the search operation history up to this stage increases and exceeds the threshold. Then, as illustrated in FIG. 11, the search result is displayed.

When the display of the search result is performed, the adjustment unit 309 monitors the utilization of the search result. In other words, it is monitored whether or not an instruction to open the file displayed as the search result is inputted. For example, when the utilization of the search result is not detected within the predetermined time since the display of the search result, it is determined that there is no utilization of the search result. On the other hand, when the utilization of the search result is detected within the predetermined time since the display of the search result, it is determined that the utilization of the search result was made. The adjustment unit 309 updates the threshold or the like, which is used in the controller 306, according to the utilization status of the search results (step S39). For example, when the utilization of the search result was made, the first and second predetermined times may be shortened or the threshold of the fitness degree is increased assuming that the search result is displayed at an appropriate timing. Then, in a much tough condition, an appropriate timing is estimated to perform the display of the search result to the user. On the other hand, when the utilization of the search result is not made, the first and second predetermined times may be prolonged or the threshold of the fitness degree is decreased. Accordingly, the situation is surveyed on whether or not the search result is utilized next chance. However, this adjustment method is a mere example, and the reverse adjustment may be made. The degree of the adjustment may be determined based on the experimental results and the like.

Then, the processing returns to the step S1 through the terminal C.

The timing when the display of the search result is terminated may be timing after it is determined at the step S35 for the next search operation that the fitness degree is less than the threshold, for example. In such a case, there is a possibility that a case may occur that after the display was made temporarily, the display is stopped and then the display is performed again, while the search operation is repeated. In addition, when it is determined at the step S39 that there is no utilization of the search result, the display of the search result may be quit.

Accordingly, when the search result that corresponds to the browsing contents matches the search operation history of the user at a predetermined level or higher, the search result is displayed to the user. Therefore, it becomes possible to display the search result at an appropriate timing without giving no burden to the user, and impeding the operation of the user. Then, it becomes possible to heighten the utilization ratio of the search results.

Although the embodiment of this technique was explained above, the embodiment is a mere example. For example, the functional block diagram in FIG. 2 is an example, and may not correspond to a program module configuration. As for the processing flows, as long as the processing results do not change, processing turns may be exchanged or plural steps may be executed in parallel.

Furthermore, various modification may be employed for the aforementioned feature data and fitness degree. In the aforementioned example, the TF-IDF value is used. However, the simple appearance frequency of the keyword may be employed, for example. Moreover, in the aforementioned example, one fitness degree is calculated. However, the fitness degree may be calculated for each file included in the search result, for example. Then, it may be determined whether or not a statistical amount such as the total value of the fitness degrees for the respective files exceeds the threshold, and when the total value of the fitness degrees exceeds the threshold, the file of the search result maybe displayed in ascending order of the fitness degree. The search result may be arranged in order of the degree that the path name included in the search operation history is identical to the path name included in the search result.

In addition, the aforementioned information processing apparatus is a computer device as illustrated in FIG. 12. That is, a memory 2501 (storage device), a CPU 2503 (processor), a hard disk drive (HDD) 2505, a display controller 2507 connected to a display device 2509, a drive device 2513 for a removable disk 2511, an input unit 2515, and a communication controller 2517 for connection with a network are connected through a bus 2519 as illustrated in FIG. 12. An operating system (OS) and an application program for carrying out the foregoing processing in the embodiment, are stored in the

HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform predetermined operations. Moreover, intermediate processing data is stored in the memory 2501, and if necessary, it is stored in the HDD 2505. In this embodiment of this technique, the application program to realize the aforementioned functions is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the application programs systematically cooperate with each other, so that various functions as described above in details are realized.

The aforementioned embodiments are outlined as follows:

An information search support method relating to the embodiments includes: (A) upon detecting that a first operation of a user is an operation relating to browsing, performing search associated with data relating to the browsing to store a search result in a storage device; (B) first extracting first feature data from the search result stored in the storage device; (C) upon detecting that a second operation of the user after the first operation is an operation relating to searching, adding data relating to the second operation to an operation history; (D) second extracting second feature data from the operation history; (E) calculating a fitness degree between the first feature data and the second feature data; and (F) upon detecting that the fitness degree is equal to or greater than a threshold, displaying the search result stored in the storage device for the user.

When the search operation that matches the result of the search that is performed based on the browsing is performed, the possibility is high that the result of the search is effectively utilized. Therefore, when the result of the search is displayed at a timing when the search operation that matches the result of the search was performed as assuming the timing when the user desires, no burden is given to the user and no trouble is given to the user.

In this information search support method, until the fitness degree becomes equal to or greater than the threshold or until another operation relating to second browsing is performed, the adding, the second extracting and the calculating for a user's operation relating to searching may be repeated. By dynamically calculating the fitness degree along with the flow of the search operation, it becomes possible to display the result of the search at an appropriate timing.

In addition, in this information search support method, until an interval between operations relating to searching exceeds a first predetermined value, until the interval between operations relating to searching after a predetermined time period elapsed since the operation relating to browsing exceeds the first predetermined value, until the fitness degree becomes equal to or greater than the threshold, or until another operation relating to second browsing is performed, the adding, the second extracting and the calculating for an operation relating to searching may be repeated. The effectiveness of the result of the search may be determined based on the time. In other words, whether or not the effectiveness of the search result is decreased because of the change of the user's viewpoint may be determined based on the time from the browsing and the interval of the search operations.

Moreover, this information search support method may include: changing the threshold according to whether a predetermined operation was performed by the user for the search result displayed for the user. Thus, it becomes possible to display the search result at a much appropriate timing.

Furthermore, this information search support method may further include: changing the threshold or the predetermined time period according to whether a predetermined operation was performed by the user for the search result displayed for the user. Thus, it becomes possible to display the search result at a much appropriate timing.

Furthermore, the second feature data may include first character strings concerning a name of data or a storage area, which is a target of the operation relating to searching, or a first vector of weights of the first character strings. Moreover, the first feature data may include second character strings concerning the search result or a name of a storage area that is an extraction source of the search result or a second vector of weights of the second character strings. Furthermore, the aforementioned fitness degree may be a matching degree between the first character strings and the second character strings or an inner-product of the first vector and the second vector. Various kinds of fitness degree may be employed.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A non-transitory computer-readable storage medium storing a program for causing a computer to execute a process, the process comprising:
upon detecting that a first operation of a user is an operation relating to browsing, performing search associated with data relating to the browsing to obtain a search result;
first extracting first feature data from the search result;
upon detecting that a second operation of the user after the first operation is an operation relating to searching, adding data relating to the second operation to an operation history;
second extracting second feature data from the operation history;
calculating a fitness degree between the first feature data and the second feature data; and
upon detecting that the fitness degree is equal to or greater than a threshold, displaying the search result for the user.

2. The non-transitory computer-readable storage medium as set forth in claim 1, wherein the process further comprises:
until the fitness degree becomes equal to greater than the threshold or until another operation relating to second browsing is performed, repeating the adding, the second extracting and the calculating for a user's operation relating to searching.

3. The non-transitory computer-readable storage medium as set forth in claim 1, wherein the process further comprises:
until an interval between operations relating to searching exceeds a first predetermined value, until the interval between operations relating to searching after a predetermined time period elapsed since the operation relating to browsing exceeds the first predetermined value, until the fitness degree becomes equal to or greater than the threshold, or until another operation relating to second browsing is performed, repeating the adding, the second extracting and the calculating for an operation relating to searching.

4. The non-transitory computer-readable storage medium as set forth in claim 1, wherein the process further comprises:
changing the threshold according to whether a predetermined operation was performed by the user for the search result displayed for the user.

5. The non-transitory computer-readable storage medium as set forth in claim 3, wherein the process further comprises:
changing the threshold or the predetermined time period according to whether a predetermined operation was performed by the user for the search result displayed for the user.

6. The non-transitory computer-readable storage medium as set forth in claim 1, wherein the second feature data includes first character strings concerning a name of data or a storage area, which is a target of the operation relating to searching, or a first vector of weights of the first character strings,
the first feature data includes second character strings concerning the search result or a name of a storage area that is an extraction source of the search result or a second vector of weights of the second character strings,
the fitness degree is a matching degree between the first character strings and the second character strings or an inner-product of the first vector and the second vector.

7. An information search support method, comprising:
upon detecting that a first operation of a user is an operation relating to browsing, performing, by using a computer, search associated with data relating to the browsing to obtain a search result;
first extracting, by using the computer, first feature data from the search result;
upon detecting that a second operation of the user after the first operation is an operation relating to searching, adding, by using the computer, data relating to the second operation to an operation history;
second extracting, by using the computer, second feature data from the operation history;
calculating, by using the computer, a fitness degree between the first feature data and the second feature data; and
upon detecting that the fitness degree is equal to or greater than a threshold, displaying, by using the computer, the search result for the user.

8. An information processing apparatus, comprising:
a memory; and
a processor configured to execute a process, the process comprising:
upon detecting that a first operation of a user is an operation relating to browsing, performing search associated with data relating to the browsing to obtain a search result;
first extracting first feature data from the search result;
upon detecting that a second operation of the user after the first operation is anoperation relating to searching, adding data relating to the second operation to an operation history;
second extracting second feature data from the operation history;
calculating a fitness degree between the first feature data and the second feature data; and
upon detecting that the fitness degree is equal to or greater than a threshold, displaying the search result for the user.
